(19) United States
(12) Patent Application Publication
(10) Pub. No.: US 2024/0008393 A1
(43) Pub. Date: Jan. 11, 2024

(54) METHOD TO ANAEROBICALLY TREAT FLUSH DAIRY MANURE

(71) Applicant: Sustain Technologies, LLC, Charlotte, NC (US)

(72) Inventor: Robert Hickey, Okemos, MI (US)

(21) Appl. No.: 17/861,643

(22) Filed: Jul. 11, 2022

(51) Int. Cl. A01C 3/00; C02F 1/44; C02F 1/20; C02F 11/04

(52) U.S. Cl. CPC A01C 3/00; C02F 1/444; C02F 1/20; C02F 11/04

(57) ABSTRACT

An improved treatment of manure from animal husbandry results from using a hybrid upflow, anaerobic contact reactor that maintains a flocculent bed of solids in combination with a microfiltration/ultrafiltration system and a recycle flow arrangement. This hybrid anaerobic contact reactor arrangement provides a high conversion of COD and volatile suspended solids in the anaerobic contact reactor by maintaining a flocculent region of solids and direct recycle of an aliquot portion of the effluent stream from the anaerobic contact reactor. The direct recycle facilitates the adjustment of the hydraulic retention time versus the solids retention time within the anaerobic contact reactor. The provision of concentrate from the microfiltration/ultrafiltration system increases solids retention time in the anaerobic contact reactor. This arrangement eliminates additional processing steps and equipment typically used in treating flush manure.

### FIELD OF THE INVENTION

The present invention relates to methods for treating flush manure from farming and livestock operations for ruminant animals. In further detail this invention involves a method for the processing of suspended solids (SS) contained in streams of flush manure emanating from such operations. More specifically this invention applies to arrangements combining anaerobic digestion and micro/ultrafiltration membranes to reduce the concentration of suspended solids (SS) in flush manure liquids while producing recyclable water and one or more of products/energy and biogas.

### BACKGROUND OF THE INVENTION

Animal wastes contribute more than half of the biomass-based wastes generated in the United States and elsewhere. A significant part of this waste comes from the pens and barns of ruminant animals such as cows and cattle. Ruminant manure from a typical ruminant animal house consists of feces, urine, bedding materials, split feed, split drinking water, and water used for washing the pen and it will be collected below slatted flooring as slurries. The excretions are separated into solid manure, known as farmyard manure. A water flush removes remaining solids as flush manure. Methods and systems for treating the water and solids in flush manure from the pens and barns of ruminant animals such as cows and cattle must meet many specific requirements. An overriding criterion is efficiently processing large flows of very dilute manure.

For example, dairy farms present perhaps the most prevalent application of water flushing systems that produce flush manure. Flushing of barn and pen floors that house cows and collecting flush water and manure in the alleys and/or sand lanes produces a water stream with a dilute solids content that can be less than 2% total solids. This dilute loading of solids requires that methods and systems perform effectively and efficiently to separate a large volume water flow containing very dilute manure and make solids and water recovery practical.

The flush manure usually passes to treatment facilities that remove solids from the flush manure and make the water suitable for again flushing livestock facilities or other uses. The constituents of animal waste find a wide variety of beneficial uses. Organic carbon in animal wastes can provide a major source of renewable energy as methane gas. The high protein production of ruminant animals also makes their waste rich in organic nitrogen (N) that serves as a source of producing fertilizers and other nitrogenous compounds. Remaining solid residues from the treatment of ruminant animal waste can also provide nutrient rich fertilizers, soil adjuvants, and soil amendments. Thus, the most useful systems and methods will enable a high recovery of these outputs and products.

A wide variety of equipment in a plurality of configuration recover valuable products from animal waste. Treatment of flush manure from ruminant animals starts with removing fibrous solids to produce a liquid stream comprising primarily water and containing suspended solids that include biological material in the form of volatile suspended solids. Removal and conversion of the suspended solids purifies the water and concentrates the remaining solids. The purification removes most of the remaining solids from the liquid to provide recycle water. Most commonly anaerobic digestion (AD) provides the essential breakdown of soluble and suspended solids contained in the flush manure with high COD removal efficiencies and low sludge production. In addition to AD, methods and systems integrate one or more of separation, stripping, scrubbing, and contacting into a complete process for treating flush manure.

Thus, anaerobic digestion of suspended solids from manure produces a digestate stream comprising mainly water and suspended solids and a biogas that contains the methane. The digestate and the biogas will contain a variety of other chemical compounds. Normally the digestate normally also includes nitrogen containing compounds and some amount of phosphorus and potassium.

Additional biogas components primarily comprise sulfur compounds, most prevalently as H2S, and CO2. The purification of the biogas to useable methane, typically in the form of an RNG stream, requires removal of the CO2 and sulfur compounds. Those skilled in the art know a wide range of methods to treat/remove H2S and CO2 from gas streams. Such treatments include oxidation of H2S that can also provide a source of sulfuric acid and various adsorbent media that can remove H2S as well as other sulfurous contaminants such as mercaptans and CO2. Additional H2S removal methods include feeding biogas to a scrubber that can use a variety of scrubbing media; the use of scavenger materials; amine treatment that can remove CO2 and H2S; and aeration systems.

Nitrogen compounds present in the flush manure or produced by the digestion of many organic materials will usually produce ammonia and ammonium compounds. In addition, further processing of the recovered solids can result in the formation of ammonium bicarbonate and ammonium carbonate. Accordingly, the flush manure provides a valuable source for extracting high value products.

Livestock and dairy operation benefit from these systems in other ways. The production of a purified water stream keeps the retention lagoon substantially cleaner. Thus, Livestock and dairy operation benefit from these systems in numerus ways. The production of a purified water stream keeps the retention lagoon substantially cleaner. The cleansed water can also improve the flushing of the sand lanes or alley flush.

Methods for treating flush manure require a concatenation many process units in a variety of flow arrangements, unit operation and controls. Fine tuning of these process elements and their operation typically adds complexity to the arrangements which translates to cost in both equipment and operation.

U.S. Pat. No. 10,781,143 treats organic waste containing fibrous material by recovering coarse fibers that pass to a biogas digester and mechanically separates the effluent from the biogas digester into a concentrated fraction and a liquid fraction. The liquid fraction after heating to a temperature below the liquid's boiling point enters a flash column to partially removes volatile carbon dioxide. The heated flash liquid passes to an ammonia removal unit that removes ammonia from the liquid. The ammonia free liquid passes through a reverse osmosis unit for the recovery of an ammonia free liquid and a potassium rich fraction useful as a fertilizer concentrate.

U.S. Pat. No. 9,656,895 discloses a process arrangement for treating waste stream containing biodegradable organic substances that feeds the waste stream into an anaerobic bioreactor containing liquid biomass and passing the bioreactor a first effluent flow to a membrane filtration unit in which said feed is subjected to filtration thereby forming a permeate stream and a retentate stream. The retentate stream returns to the bioreactor. A second effluent flow from the bioreactor flow to a sludge treatment unit that produces a third flow stream having an increased organic substance content compared to the second flow, and a fourth flow stream having a decreased organic substance content compared to the second flow stream.

U.S. Pat. No. 9,656,895 feeds the aqueous waste stream of biodegradable material into an anaerobic bioreactor or anaerobic digester that contains biomass and reacts the biodegradable material with the biomass to form methane. A portion of the bioreactor effluent passes to a membrane filtration unit that produces a retentate for returns to the bioreactor. Another portion of the bioreactor effluent passes to one or more sludge treatment units that provide a treated sludge, a portion of which may pass to the bioreactor along with a flocculation or coagulation additive.

Those of ordinary skill in the art know of anaerobic contact reactors that provide anaerobic digestion of suspended solids and arrangement of such reactors that recycle the effluent of the reactor directly back to the inlet.

U.S. Pat. No. 9,416,038 discloses a plant for treating manure in an anaerobic digester and then mechanically dewatering the digestate that may flocculate the digestate with the addition of a flocculant or polymer. The dewatering device can produce centrate that undergoes further processing.

U.S. Pat. No. 9,809,481 describes a digester that receives thickened a waste stream. The digestate passes through a separator to provide a coarse separation. A portion of the separated solids may return to the digester.

U.S. Pat. No. 10,183,883 pertains to a methane fermentation system which can efficiently generate methane gas wherein an anaerobic microorganism decomposes a waste by methane fermentation to generate methane gas. The methane fermentation system finely pulverizes the organic waste with a wet bead mill.

U.S. Pat. No. 10,144,664 describes a waste stream digester that produces a digestate and passes it through two stages of separation and/or thickening and then returns a remaining fraction of the digestate to the digester.

WO 2005/058764 relates to an anaerobic digester that receives an organic waste liquid in which a concentrator concentrates the digested sludge that then returns to a digester.

U.S. Pat. Nos. 8,486,359 and 8,580,219 disclose methods for recovering ammonium carbonate and ammonium bicarbonate from wastewater associated with the digestion of organic wastes.

U.S. Pat. Nos. 10,793,458, 10,604,432, and 10,106,447 show recovery of ammonium carbonate (AC) and ammonium bicarbonate (AB) by anaerobically digesting agricultural, municipal and/or industrial wastewater and concentrating gaseous ammonia to produce AB and AC from wastewater containing ammonia using gas separation, condensation, and filtration, at controlled operating temperatures.

Dahlan et al, (J Adv Sci Res, 2013, 4(1): 07-12 Journal of Advanced Scientific Research, 2013,) describe the use of anaerobic digester that retains a flocculent bed and can operate with high or low rates to treat high levels of organic and suspended solids in waste streams.

The preceding description represents only a sampling of the many equipment arrangements and processing methods for treating waste streams including animal waste streams that constitute advanced manure systems. The originators of these methods and others continue to seek improvements in efficiency, overall recovery of solids, discharged water purity, production of high value products and energy recovery. These extended treatments add additional contacting steps, filtration steps and recovery steps. While these steps can improve conversion of soluble and suspended solids, the additional steps increase the cost and complexity of using such systems.

Thus, methods are sought that can simplify the conversion of waste materials and the recovery of the water, products, and energy recovery.

### SUMMARY

This invention brings new practicality and cost savings to the treatment of manure from husbandry of animals by using a hybrid upflow, anaerobic contact reactor (ACR) that maintains a flocculent bed of solids in combination with MF/UF system and a recycle flow arrangement in a newly discovered method for its operation. The method uses this hybrid ACR arrangement to provide a high conversion of COD and volatile suspended solids (VSS) in the ACR by maintaining a flocculent region of solids in an ACR vessel and direct recycle of an aliquot portion of a liquid effluent stream that exits the ACR and that contains a significant loading of TSS/VSS. This direct recycle facilitates the adjustment of the hydraulic retention time (HRT) versus the solids retention time (SRT) within the ACR and the combination with the provision of concentrate from the MF/UF allows the retention of solids in ACR for longer periods of time. The ACR, flow arrangement and method eliminate much of the additional processing steps and equipment typically required in treating flush manure from animals (flush manure (FM)). Thus, this invention provides a novel way to obtain high VSS (particulate COD) removal and water recovery along with the recovery of products and energy from FM.

In further detail this invention provides an efficient and highly cost-effective treatment of FM by combining an upflow, flocculant bed, ACR that operates with a dual recycle arrangement to adjust the liquid flow through the ACR and the loading of solids in a flocculant bed of the ACR for desired periods of time. This is an important part of the system to further adjust SRT compared to HRT. The flow and equipment arrangement of this system thereby gives high conversion of solids to gaseous and soluble components while reducing equipment needs which lowers costs and reduces the operating complexity of the system. Thus, the method of this invention enables the treatment of FM with reduced capital and greater adaptability to variations in FM and the suspended solids concentration contained therein.

This invention separates the ACR effluent using a microfiltration membrane system and/or an ultrafiltration membrane (MF/UF) unit that concentrates solids into a concentrate stream and a permeate stream comprising water that is relatively free of particulate material. In most cases the cleanliness of recycled water makes it suitable for irrigation and even high efficiency drip irrigation. This invention's unique operation of the ACR and direct recycle reduces the overall particle load on these downstream membrane systems.

Another advantage of the invention is the ability to recycle ACR effluent directly to the ACR. Thus, the ACR may receive direct recycle of ACR effluent, a portion of the concentrate stream, and/or a portion of a purified water stream recovered from the MF/UF unit. Adjustment of the direct ACR effluent recycle volume versus the volume addition, if any, of the concentrate stream and/or the purified water stream provides flexibility in the management of the ACR's flocculent bed and the conversion of particulate material therein. Accordingly, the ACR can readily adapt to variations in the solids loading from the FM liquid.

A further advantage of the invention is the ability to reduce the size of the MF/UF unit. The coupling of the ACR with the treatment of the concentrate from the separation unit increases the solids retention time in the ACR by a sufficient amount to reduce the required size of the separation unit. This is the result of not needing to have all of the ACR effluent go through the MF/UF unit. Accordingly, the size and the cost of the membranes in the MF/UF unit will be considerably less than a conventional ACR and MF/UF arrangement.

In a first broad embodiment the invention initially treats the raw FM stream in a pretreatment zone that removes coarse fibrous solids and provides an FM liquid containing TSS/VSS, a soluble COD (sCOD), and highly degradable particulate COD (pCOD). At least a portion of the FM liquid passes to an ACR that operates with sufficient upward liquid velocity to maintain suspended solids (SS) as a flocculent bed in the lower portion of the ACR. The ACR converts the sCOD and pCOD to a gas stream comprising methane and CO2 and a liquid ACR effluent stream having reduced concentrations of sCOD and pCOD relative to the FM liquid. An upper portion of the ACR vents the gas stream, preferably for methane recovery and additional processing. An aliquot portion of the ACR effluent stream returns directly to the ACR to provide additional liquid and solids. The additional liquid maintains in part the desired upward liquid flow in the ACR such that the flocculant bed is maintained with an increased retention time of solids in the ACR. A portion of the ACR effluent stream passes to at least one MF/UF unit that separates the ACR effluent stream into a permeate stream comprising primarily water and a concentrate stream having an increased concentration of SS relative to the ACR effluent stream. Another aliquot portion of the ACR effluent stream bypasses the MF/UF unit to provide an ACR discharge stream for disposal, recovery, and/or further utilization. At least a portion of the concentrate stream passes to the ACR to provide additional liquid and solids to in part maintain the desired upward fluid flow in the ACR such that the flocculant bed is maintained with an increased retention time of solids in the ACR. The method also discharges at least a portion of permeate stream to provide a permeate discharge for disposal, recovery and/or further utilization. In most cases no chemicals are added in practicing the method.

In a further arrangement of the first embodiment a portion of the concentrate stream is discharged to provide a concentrate discharge for disposal, recovery, or further utilization. The permeate discharge may pass to a lagoon from which it can provide manure flush water. The FM contains nitrogenous compounds and at least one of the ACR discharge, the permeate discharge and the concentrate discharge may be treated to recover ammonium and/or ammonium compounds. At least a portion of the concentrate discharge may pass to a solids management zone that produces a converted concentrate discharge suitable for product production or energy recovery. The solids management zone may screen and/or centrifuge the concentrate discharge stream to produce concentrated solids and may then dry the concentrated solids to produce nutrient rich solids suitable for use as fertilizer or a soil amendment

In another more limited aspect of the first embodiment, the pretreatment zone includes a separation unit for separating coarse solids and/or a biological treatment unit. When present, the biological pretreatment unit converts a portion of the pCOD to sCOD to reduce the TSS/VSS concentrations going the ACR.

In another arrangement of the first embodiment the pretreatment zone includes a separation unit and biological treatment unit. In one case FM passes to a separation unit that comprises screening and a screened FM stream then passes to a biological treatment unit. In another case the FM stream passes to a biological treatment unit and the biologically treated FM passes to a solids removal unit comprising at least one of centrifugation and membrane filtration.

In another arrangement of the first embodiment at least a portion of the permeate discharge is stripped using air to remove dissolved CO2 and dissolved ammonia, and to produce a stripped permeate. The stripped permeate may pass to a gas scrubber using CO2 that produces an ammonia bicarbonate solution.

In another more limited application this invention is particularly suitable for treating FM emanating from husbandry of ruminant animals. Flush manure from ruminant animal husbandry contains higher loadings of coarse fibrous solid when compared with other animal husbandry operation such as pig farming.

A second embodiment the invention again reduces the concentration of coarse fibrous solids and suspended solids (SS) in FM using anaerobic conversion and initially treats the raw FM stream in a pretreatment zone to remove coarse fibrous solids and provide an FM liquid containing TSS/VSS, soluble COD (sCOD) and highly degradable particulate COD (pCOD). As in the first embodiment at least a portion of the FM liquid passes to an ACR that operates with sufficient upward liquid velocity to maintain suspended solids (SS) as a flocculent bed in the lower portion of the ACR and the ACR converts the sCOD and pCOD to a gas stream comprising methane and CO2 and a liquid ACR effluent stream having reduced concentrations of sCOD and pCOD relative to the FM liquid with an upper portion of the ACR venting the gas stream. This second embodiment also returns an aliquot portion of the ACR effluent stream directly to the ACR to provide additional liquid to in part maintain the desired upward fluid flow in the ACR such that the flocculant bed is maintained with an increased retention time of solids in the ACR and at least a portion of the ACR effluent stream also passes to at least one of a MF/UF unit that separates the ACR effluent stream into a permeate stream comprising primarily water and a concentrate stream having an increased concentration of SS relative to the ACR effluent stream. Also as in the first embodiment an aliquot portion of the ACR effluent stream is discharged in a manner that bypasses the MF/UF unit to provide an ACR discharge stream for disposal, recovery, and/or further utilization and passes a portion of the concentrate stream to the ACR to provide additional liquid to in part maintain the desired upward fluid flow in the ACR such that the flocculant bed is maintained with an increased retention time of solids in the ACR. Unlike the first embodiment at least a portion of the permeate stream passes to a nitrogen recovery section to produce an ammonium stream comprising ammonium and/or ammonium bicarbonate and a stream suitable for use as flush water. A portion of the concentrate stream passes to a solids management zone that treats the concentrate stream to produce a converted stream suitable for product production or energy recovery.

In a third embodiment the invention again reduces the concentration of coarse fibrous solids and suspended solids (SS) in FM using anaerobic conversion and initially treats the raw FM stream in a pretreatment zone to remove coarse fibrous solids and provide an RFM liquid containing TSS/VSS, soluble COD (sCOD) and highly degradable particulate COD (pCOD). As in the first embodiment at least a portion of the FM liquid passes to an ACR that operates with sufficient upward liquid velocity to maintain suspended solids (SS) as a flocculent bed in the lower portion of the ACR and the ACR converts the sCOD and pCOD to a gas stream comprising methane and CO2 and a liquid ACR effluent stream having reduced concentrations of sCOD and pCOD relative to the FM liquid. The gas stream vents from an upper portion of the ACR. This third embodiment also returns an aliquot portion of the ACR effluent stream directly to the ACR to provide additional liquid to in part maintain the desired upward fluid flow in the ACR such that the flocculant bed is maintained with an increased retention time of solids in the ACR. Also, as in the first embodiment an aliquot portion of the ACR effluent stream is discharged in a manner that bypasses the MF/UF unit to provide an ACR discharge stream for disposal, recovery, and/or further utilization. Unlike the first embodiment this embodiment discharges a portion of the ACR effluent stream directly to a nitrogen recovery section to produce an ammonium stream comprising ammonium and/or ammonium bicarbonate and a nitrogen recovery section effluent stream comprising SS and including VSS that passes to the UM-M unit and at least a portion of the permeate stream is discharged for disposal, recovery and/or further utilization. A portion of the permeate stream may pass to the ACR for supplying additional liquid.

The following figures and description disclose equipment and arrangements for practicing the method of this invention from which further embodiments will be apparent.

### BRIEF DESCRIPTION OF THE DRAWINGS

FIG. 1 is a flow diagram for the practice of the invention showing an ACR, a MF/UF unit, and a solids management section arranged in accordance with this invention.

FIG. 2 is a flow diagram for the practice of the invention showing an ACR, a MF/UF, and a solids management section arranged in accordance with this invention that includes nitrogen recovery, H2S removal and biogas upgrading.

FIG. 3 is a flow diagram for the practice of the invention showing a variation in the arrangement of the processing unit shown in FIG. 2

### DETAILED DESCRIPTION

Any advanced FM manure treatment method requires the basic steps of separating fiber from the FM; treating the resulting FM liquid to breakdown suspended solids; and separating solids from the liquid effluent of the FM treatment. Advanced FM manure treatment methods use a wide variety of equipment and equipment arrangements to carry out these basic steps. In addition to these basic steps most FM treatment method involve additional treatment steps and ancillary equipment to tailor the method to specific characteristics of the FM and the desired outputs.

Initially raw FM recovered by the flushing of husbandry animal stalls, housing, and areas of confinement contain a high fiber loading. Such fiber typically comprises undigested and/or partially digested animal feed along with straw, sawdust, or other bedding that becomes mixed with the manure. Removal of fiber is essential to the processing of the remaining FM primarily because of the lignin and lignin-carbohydrate complexes present in grasses which are resistant to breakdown comprise a large portion of the undigested animal feed along with saw dust that may be present. Recovered fiber can also have value in a wide range of other uses from fuel product, animal bedding and even construction materials.

This invention starts with fiber treatment that will at minimum separate, from the raw FM, the larger fibrous suspended solids and other suspended solids that will not contribute significantly to the amount of methane produced by this method. Equipment for basic fiber removal is well known and will comprise dewatering and compression larger solids. Centrifuges, screw presses, high-capacity drum screens coupled with screw or roller presses can capture most of the fibrous manure particles. This type of equipment will deliver an FM liquid essentially devoid of fibers and having a lower concentration of TSS.

The fiber treatment may include additional screening of TSS and/or biological pretreatment. Biological pretreatment enhances the amount of hydrolysis of the smaller particulate COD and acidification to organic acids. Preferred arrangements will include both screening and biological treatment in either order—screening for TSS removal followed by biological pretreatment or biological pretreatment followed by TSS removal using unit processes such as centrifuging or membrane filtration.

The FM liquid essentially free of large solid matter passes to an anaerobic treatment step to breakdown TSSNSS contained therein. The anaerobic treatment step of this invention uses an anaerobic contact process in the form of an anaerobic contact reactor (ACR). The ACR is an upflow hybrid anaerobic contact reactor that retains a flocculent (i.e. non-granular) sludge with high levels of organic and suspended solids. The ACR of this invention operates with much longer SRT than HRT. The ACR comprises a vertically extended tank or vessel that operates at a liquid upflow velocity that results in retention of the TSS after fiber removal as a “blanket” with higher TSS at the vessel bottom and gradually diminishing TSS concentration at higher elevations in the vessel. This further enhances the overall SRT for the solids ensuring the highest COD conversion efficiency.

An ACR effluent is withdrawn from the ACR vessel, a portion of which directly contributes to the maintaining the desired SRT. More specifically the ACR achieves longer SRT in a simple and readily controllable manner by recycling an aliquot portion of the ACR effluent directly back into the ACR in combination with the MF/UF that allows the longer retention time of the solids. The effluent contains TSS/VSS that the direct recycle returns to the ACR. As hereinafter described the ACR can also receive a portion of a concentrate stream containing TSS/VSS recovered from the ACR effluent and/or a portion of a purified water stream derived from the ACR effluent.

Returning a portion of the concentrate stream or purified water stream allows greater control of the TSS loading in the ACR and the ACR's HRT and SRT. For example, recycling a portion of concentrate or purified water can enable further control the overall particle density of the liquid that gets recycled to ACR. Thus, the direct recycle of the ACR effluent combined with the selective return of concentrate or purified water provide, in addition to HRT and SRT adjustment, great flexibility in maintaining desired mixing; liquid flow-distribution; agitation within the ACR; and internal recycling of particle sludge.

After the direct recycle of a portion of the ACR effluent, the remaining ACR effluent passes at least in part to a solids removal/solids concentration step that uses an MF/UF unit. The MF/UF unit separates the ACR effluent into a concentrate stream and a permeate stream. The concentrate stream contains a high density of particles in the liquid. The permeate stream contains no more than trace amounts of pCOD.

The MF/UF unit will typically have a microfiltration or ultrafiltration section. A typical microfiltration membrane with a pore size ranges from 0.5 microns or above. The pore size of ultrafiltration membrane typically range between 0.05 and 0.2 microns.

Whether it uses ultrafiltration or microfiltration the MF/UF section will usually include multiple modules. Available modules configurations and module materials are well known to the skilled in the art. Typical module configurations include flat sheet, tubular, and hollow fiber. Any of the well-known classes of membrane material will give suitable performance. Well know classes of membrane materials include ceramic membranes, stainless steel, polymeric membranes, and composite membranes. Commonly used materials include cellulose acetate, polyvinyl chloride, polysulfones, polycarbonates, and polyacrylonitriles. Purity requirements and pressure drop considerations will determine the number of modules, their sizing, and their operating conditions. Ceramic or stainless-steel membranes are preferred

Because the MF/UF permeate contains at most trace TSS and essentially consists of water it can be used directly or from a storage lagoon for land use by a conventional irrigation system, such as a center pivot system, with no plugging issues. When sent to lagoons, the purity of the permeate water eliminates the need for dragging the effluent lagoons to remove settled solids. The “no TSS” condition of the permeate makes additional downstream processing easier.

As previously described, a portion of the concentrate TSS of the MF/UF unit typically returns to the anaerobic contact reactor with one or more stream derived from the concentrate stream. This TSS return further increases the solids retention time, thereby improving the conversion of the VSS to methane.

The method of this invention can include additional processing steps and equipment. Specifically, VSS retained in the concentrate may be wasted or otherwise further processed in a concentrated form. Options for further processing these wasted solids can involve further concentration and drying using any number of well-known approaches to both unit operation. Preferably, these unit operations are done without chemical addition so the material does not lose its “organic” designation and associated higher value.

### DETAILED DESCRIPTION OF THE DRAWINGS

A more complete description of the invention is given in conjunction with the following detailed description of the figures. A network of flow meters, sensors, pumps, compressors, controls, and control loops ensure smooth operation from feed to output and every step in between. For clarity the figures omit such additional process equipment that is well known to those skilled in the art and readily incorporated without explanation.

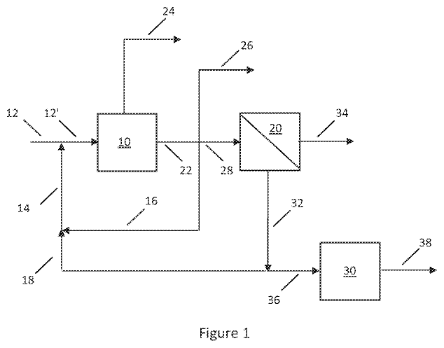

FIG. 1

FIG. 1 shows a basic arrangement for the practice of this invention with an ACR 10, a MF/UF unit 20, and a solids management unit 30. FIG. 1 also shows the necessary and optional lines that interconnect these units in a manner to practice this invention.

A feed stream 12 supplies an FM liquid to ACR 10 as the basic feed to the process. A recycle stream 14 supplies at minimum a direct recycle of an aliquot portion of ACR effluent stream 22 via a direct recycle stream 16. An optional concentrate recycle stream 18 passes a portion of concentrate from the MF/UF unit. FIG. 1 shows an arrangement for all of streams 12, 14, 16, and 18 to flow into ACR 10 as a combined input stream 12′. Together streams 12, 16, and optionally 18 produce a flocculent bed in the ACR having the desired upflow velocity and disengagement of the gas stream produced therein.

Different arrangements for practicing the method of this invention may introduce liquid and particles via streams 12, 14, 16, and 18 into ACR 10 in a variety of ways. Combined input stream 12′ may enter the ACR through a plurality of inlet nozzles. Similarly, any streams 12, 14, 16, and 18 may be combined with to produce a combined input stream that enters ACR 10 through one of more inlets. Any such stream or combined stream may enter ACR 10 through multiple inlet nozzles spaced about an ACR vessel (not shown) to distribute the input streams over circumference and/or different elevations of an ACR vessel. In a similar manner effluent stream 22 may exit the ACR vessel through multiple liquid effluent nozzle distributed circumferentially and/or at different height with all such nozzle preferably located above any input nozzles. Preferably any input streams will enter ACR 10 at a lower vessel elevation and any liquid effluent from ACR 10 will exit above the top region of the flocculent bed and all of the entry locations of feed and recycle components into ACR 10.

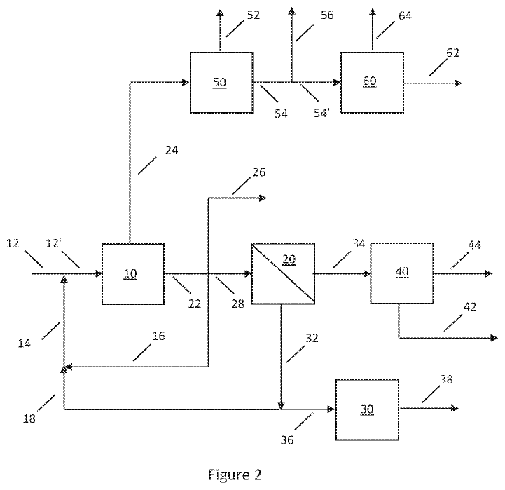

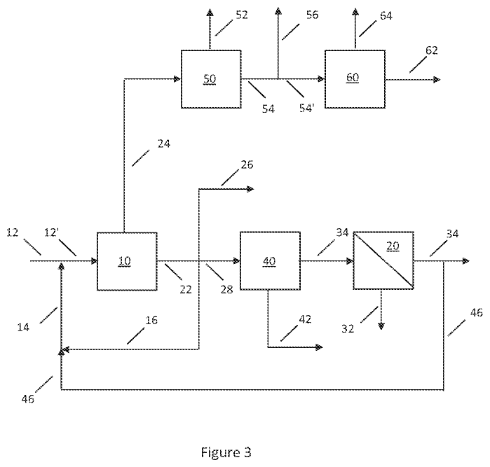

The breakdown of VSS produces an ACR gas stream 24 that comprises mainly methane and lesser amounts of sulfur compound. ACR gas stream 24 exits ACR 10 at an upper location of the ACR vessel. Gas stream 24 typically includes dissolved CO2 and ammonia and exits from an upper portion of the ACR vessel as off a gas stream. As shown in FIGS. 2 and 3, gas stream 24 will in almost all gases undergo further processing for recovery of a purified biogas/green methane, and sulfur compounds along with a rejection of CO2.

Upon exiting ACR 10 effluent stream 22 divides into at least a MF/UF unit feed stream 28; a waste stream 26 and the direct recycle stream 16. Recycle stream 16 will typically directly return a liquid volume of from 1.5 to 1.9 times the total volume of the liquid entering the ACR waste stream 26 may go to a lagoon for use as flush water and/or NH3 removal. The portion of ACR effluent 22 by streams 26 and 16 reduces the separation load on the MF/UF unit and can lead to a reduction in the required size of membrane separation unit. In addition, selective passing of a portion of the permeate stream provides more means for controlling SRT in ACR 10 as previously described.

MF/UF unit separates TSS/VSS from the ACR effluent using any of the membranes or combination of membranes in the manner previously described to produce a concentrate stream 32 and a permeate stream 34. Permeate stream 34 contains essentially no pCOD and comprises mainly treated water and will typically contain soluble ammonia compounds. Stream 34 may pass directly to a holding lagoon and/or find use as flush water. In addition to or alternatively all or a portion of permeate stream may undergo ammonia recovery and subsequent use in solid product or liquid product production.

Concentrate stream 32 has a variety of uses. At least a portion of concentrate stream 32 usually returns to ACR 10 and may enter the ACR vessel at any point and by direct flow or in combination with any other stream entering ACR 10 in any of the ways previously described. FIG. 2 shows an arrangement where a portion of concentrate stream 32 flows into ACR 10 via streams 18, 14, and 12′. The volume of concentrate stream entering ACR 10 will usually range from 0.3 to 0.6 times the total volume of liquid entering ACR 10. At least another portion of stream 32 leaves the core arrangement of the invention as a concentrate waste stream 36.

Waste stream 36 may undergo additional treatment/processing to manage or utilize the solids contained therein. FIG. 1 shows waste stream 36 passing into a solids management unit 30. Unit 30 has an outlet 38 that can provide a variety of outputs including solid products, recovered liquid and/or energy. In most cases unit 30 will provide ammonia, ammonia derivatives and/or energy production (not shown).

FIG. 2

FIG. 2 expands the processing steps of those shown in FIG. 1 by adding a nitrogen recovery section 40, an H2S removal section 50 and a biogas upgrading section 60. All the description of FIG. 1 applies to the method represented by FIG. 2 and like numbering between FIGS. 1 and 2 describe the same elements.

In this arrangement permeate stream 34 passes to nitrogen recovery section 40 that further process at least a portion of the permeate. Nitrogen recovery section 40 may integrate numerous different process steps (not individually shown) in the processing of permeate stream 34. At minimum the nitrogen recovery stream provides a purified water stream 44 that is deficient in ammonia and a stream 42 that contains ammonia removed from permeate by nitrogen recovery section 40. Thus, nitrogen recovery section 40 can provide ammonia via recovery stream 42.

In one case, recovery section 40 may strip permeate using air (not shown). Air stripping reduces both the dissolved CO2 and dissolved ammonia in the permeate. In this case recovery stream 42 recovers nitrogen/nitrogen compounds for utilization as products.

In another case, recovery section 40 includes an air/gas scrubber (not shown). In this case the stripped air/gas scrubber and recovery stream 42 will deliver a solution of ammonia and/or ammonium bicarbonate (AB). Cooling of an AB laden stream that exits the stripping gas scrubber to a temperature that promotes the precipitation of some of the dissolved AB can provide a slurry containing precipitated and/or dissolved AB. Precipitation of AB can be controlled by manipulating the pH of the scrubbing solution and the temperature of an AB laden stream stripped by the stripping gas. The AB laden stream exiting the stripping gas scrubber may also contain ammonium carbonate AC.

When ammonium bicarbonate is recovered it may be converted for solid storage and product supply to put it in a form that makes it readily available for use on farm fields when desired. It is also possible to further process it to a granular product if desired.

As an alternative to air stripping, recovery section 40 may steam strip the permeate using direct steam injection into a stripper (not shown) or by use of mechanical vapor recompression (not shown). A portion of this stripped permeate now depleted in ammonia may return to the ACR 10 (not shown) thereby reducing the ammonia level in the ACR vessel; this ensures ammonia inhibition of the anaerobic process does not occur. In addition or alternatively, the steam stripped ammonium can be recovered as an aqueous ammonia solution.

ACR 10 also produces biogas stream gas stream 24 comprising a methane rich stream gas usually referred to as biogas. A typical biogas may include 50 to 80 vol % of methane, 20 to 35 vol % of carbon dioxide, 100 to 5,000 ppm of hydrogen sulfide. Extracting useful products from the biogas requires, at minimum, initial H2S removal and, for further upgrading, removal of additional impurities. Preferably all of the treatment/removal steps for purification of the biogas are carried out without the addition of inorganic chemicals.

Accordingly, gas stream 24 passes first to H2S removal section 50. Those skilled in the art know a wide range of method to treat/remove H2S from gas streams. Different treatment/removal systems will provide varying benefits depending on characteristics of the biogas. Various adsorbent media can remove both H2S and other sulfurous contaminants such as mercaptans. Additional H2S removal methods include feeding biogas to biological treatment systems that can oxidize the sulfide to produced elemental sulfur and/or sulfate streams and cleaned biogas. Membranes and amine treatment are known to remove CO2 and H2S from such biogas streams.

H2S removal section 50, except when using adsorptive media, produces at least two output streams. Sulfurous compounds removed from the biogas exit H2S removal section 50 in sulfurous stream 52. Stream 52 will, in most systems, comprise elemental S and/or SO4. H2S removal section 50 also produces a purified biogas stream 54 containing H2S in the range of 50 to 100 ppmv, and principally methane and CO2. This H2S depleted biogas can be recovered by line 56 for energy generation on site.

Stream 54′ passes remaining purified biogas into biogas upgrade section 60. Upgrade section 60 produces an RNG stream 62 by removing other contaminants from purified biogas 54, such as residual CO2, that would disqualify stream 62 from having a designation of RNG. The removed CO2 and other trace gases (such as residual H2S, N2 etc.) removed via line 64 are vented or treated.

FIG. 3 shows another variation in the arrangement of the invention wherein nitrogen recovery section 40 is upstream of the MF/UF unit. In this variation line 28 carries the remaining ACR effluent downstream of any liquid withdrawn by waste stream 26 and direct recycle stream 16. Remaining ACR effluent flows into nitrogen recovery section 40 for removal/recovery of nitrogenous compounds/product and production of a nitrogen recovery stream 42 as described in conjunction with FIG. 2.

A nitrogen discharge stream 48 flows to MF/UF unit-20. The MF/UF unit 20 operates in the manner previously described to provide concentrate stream 32 and permeate stream 34. Concentrate stream 32 may pass to a solids management zone or other uses as previously described. A portion of concentrate stream 32 may also return to ACR 10 (not shown) in the manner previously described. At least a portion of permeate stream 34 is recovered for any further processing and the uses as previously described. A water recycle stream 46 or a portion of discharge stream 48 may flow directly to the ACR 10 (not shown) for addition to the ACR vessel in any of the ways as previously described.

The arrangement of FIG. 3 shows the option of passing a portion of permeate stream 34 to ACR 10 as purified water recycle stream 46. The recycling of purified water allows the adjustment of the liquid flow and the particle density in ACR 10.

As described, the present invention provides numerous advantages, some of which have been described above and others which are inherent in the invention. Also, modifications may be proposed without departing from the teachings herein. Accordingly, the scope of the invention is only to be limited as necessitated by the accompanying claims.

We claim:

1. A method to reduce the concentration of coarse fibrous solids and/or suspended solids (SS) in flush manure (FM) emanating from animal husbandry operations by using anaerobic conversion wherein:
a.) initially treating the FM in a pretreatment zone to remove suspended solids and any coarse fibrous solids to provide an FM liquid containing TSS, VSS, soluble COD (sCOD) and highly degradable particulate COD (pCOD);
b.) passing at least a portion of the FM liquid to an anaerobic contact reactor (ACR) having sufficient upward liquid velocity to maintain SS as a flocculent bed in the lower portion of the ACR with the ACR converting the sCOD and pCOD to a gas stream comprising methane and CO2 and an ACR liquid effluent stream having reduced concentrations of sCOD and pCOD relative to the FM liquid;
c.) Recovering and cleaning the gas stream from the ACR and upgrading to renewable natural gas (RNG);
d.) returning an aliquot portion of the ACR effluent stream directly to the ACR to provide additional liquid to in part maintain the desired upward liquid flow in the ACR such that the flocculant bed is maintained with an increased retention time of solids in the ACR;
e.) passing a portion of the ACR effluent stream to a membrane separation unit including at least one of a microfiltration unit and an ultrafiltration membrane unit that separates the ACR effluent stream into a permeate stream comprising primarily water and a concentrate stream having an increased concentration of SS relative to the ACR effluent stream;
f.) discharging an aliquot portion of the ACR effluent stream in a manner that bypasses the membrane separation unit to provide an ACR discharge stream for disposal, recovery, and/or further utilization;
g.) passing at least a portion of the concentrate stream to the ACR to provide additional liquid to in part maintain the desired upward fluid flow in the ACR such that the flocculant bed is maintained with an increased retention time of solids in the ACR; and,
h.) discharging at least a portion of permeate stream to provide a permeate discharge for disposal, recovery and/or further utilization.

2. The method of claim 1 wherein a portion of the concentrate stream is discharged to provide a concentrate discharge for disposal, recovery, or further utilization.

3. The method of claim 2 wherein at least one of the ACR discharge, the permeate discharge and the concentrate discharge passes to a lagoon from which it can provide manure flush water.

4. The method of claim 1 wherein the FM stream contains nitrogenous compounds and at least one of the ACR discharge, the permeate discharge and the concentrate discharge is treated to recover ammonium and/or ammonium compounds.

5. The method of claim 1 wherein the pretreatment zone comprises at least one of an FM separation unit for removing coarse solids and a biological treatment unit.

6. The method of claim 5 wherein the pretreatment zone includes a biological pretreatment unit that converts a portion of the pCOD to sCOD to reduce the TSS/VSS concentrations going the ACR.

7. The method of claim 1 wherein the pretreatment zone passes the FM stream to an FM separation unit that comprises screening and a screened FM stream then passes to a biological treatment unit or wherein the FM stream passes to a biological treatment unit and the biologically treated FM passes to a solids removal unit comprising at least one of centrifugation and membrane filtration.

8. The method of claim 2 wherein at least a portion of the concentrate discharge passes to a solids management zone that produces a converted concentrate discharge suitable for product production or energy recovery.

9. The method of claim 8 wherein the solids management zone screens and/or centrifuges the concentrate discharge stream to produce concentrated solids and then dries the concentrated solids to produce nutrient rich solids suitable for use as fertilizer or a soil amendment.

10. The method of claim 1 wherein no chemicals are added in practicing the method.

11. The method of claim 1 wherein at least a portion of the permeate discharge is stripped using air to remove dissolved CO2 and dissolved ammonia, and to produce a stripped permeate.

12. The method of claim 11 wherein the stripped permeate passes to a gas scrubber using CO2 and produces an ammonia bicarbonate solution.13. The method of claim 1 wherein the AC coupled with the treatment of the concentrate from the membrane separation unit increases the solids retention time in the AC by a sufficient amount to reduce the required size of the membrane separation unit.

13. The method of claim 1 wherein the animal husband operation maintains ruminant animals.

14. The method of claim 1 wherein the treating of step a.) is especially adapted for the removal of coarse fibrous solids.

15. The method of claim 1 wherein the pretreatment zone includes a biological treatment unit that converts a portion of the pCOD to sCOD to reduce the TSS/VSS concentrations going the ACR.

16. A method to reduce the concentration of coarse fibrous solids and/or suspended solids (SS) in FM flush manure (FM) streams emanating from animal husbandry operations by using anaerobic conversion wherein:
a.) initially treating the FM stream in a pretreatment zone to remove suspended solids and any coarse fibrous solids to provide an FM liquid containing TSS, VSS, soluble COD (sCOD) and highly degradable particulate COD (pCOD);
b.) passing at least a portion of the FM liquid to an anaerobic contact reactor (ACR) having sufficient upward liquid velocity to maintain SS as a flocculent bed in the lower portion of the ACR with the ACR converting the sCOD and pCOD to a gas stream comprising methane and CO2 and an ACR liquid effluent stream having reduced concentrations of sCOD and pCOD relative to the FM liquid;
c.) recovering and upgrading the gas stream from the ACR to make RNG;
d.) returning an aliquot portion of the ACR effluent stream directly to the ACR to provide additional liquid to in part maintain the desired upward fluid flow in the ACR such that the flocculant bed is maintained with an increased retention time of solids in the ACR;
e.) passing a portion of the ACR effluent stream to a membrane separation unit including at least one of a microfiltration membrane unit and an ultrafiltration membrane unit MF/UF and separating the ACR effluent stream into a permeate stream comprising primarily water and a concentrate stream having an increased concentration of SS relative to the ACR effluent stream;
f.) discharging an aliquot portion of the ACR effluent stream in a manner that bypasses the membrane separation unit to provide an ACR discharge stream for disposal, recovery, and/or further utilization;
g.) passing a portion of the concentrate stream to the ACR to provide additional liquid to in part maintain the desired upward fluid flow in the ACR such that the flocculant bed is maintained with an increased retention time of solids in the ACR;
h.) passing at least a portion of the permeate stream to a nitrogen recovery zone to produce an ammonium stream comprising ammonium and/or ammonium bicarbonate and a stream suitable for use as flush water; and,
i.) passing a portion of the concentrate stream to a solids management zone and treating the concentrate stream to produce a converted stream suitable for product production or energy recovery.

17. The method of claim 16 wherein the pretreatment zone includes a biological treatment unit that converts a portion of the pCOD to sCOD to reduce the TSS/VSS concentrations going the ACR.

18. The method of claim 16 wherein the animal husband operation maintains ruminant animals and the treating of step a.) is especially adapted for the removal of coarse fibrous solids.

19. The method of claim 16 wherein the AC coupled with the treatment of the concentrate from the membrane separation unit increases the solids retention time in the AC by a sufficient amount to reduce the required size of the membrane separation unit.

20. A method to reduce the concentration of coarse fibrous solids and/or suspended solids (SS) in flush manure (FM) from animal husbandry operations by using anaerobic conversion wherein:
a.) initially treating the FM stream in a pretreatment zone to remove suspended solids and any coarse fibrous solids to provide a FM liquid containing TSS, VSS, soluble COD (sCOD) and highly degradable particulate COD (pCOD);
b.) passing at least a portion of the FM liquid to an anaerobic contact reactor (ACR) having sufficient upward liquid velocity to maintain SS as a flocculent bed in the lower portion of the ACR with the ACR converting the sCOD and pCOD to a gas stream comprising methane and CO2 and an ACR liquid effluent stream having reduced concentrations of sCOD and pCOD relative to the FM liquid;
c.) recovering an upgrading the gas stream from the ACR to RNG;
d.) returning an aliquot portion of the ACR effluent stream directly to the ACR to provide additional liquid to in part maintain the desired upward fluid flow in the ACR such that the flocculant bed is maintained with an increased retention time of solids in the ACR;
e.) passing a portion of the ACR effluent stream to a nitrogen recovery zone to produce an ammonium stream comprising ammonium and/or ammonium bicarbonate and a recovery zone effluent stream comprising SS including VSS;
f.) passing a portion of the recovery zone effluent stream to a membrane separation unit including at least one of a microfiltration unit and an ultrafiltration membrane unit and separating the recovery zone effluent stream into a permeate stream comprising primarily water and a concentrate stream having an increased concentration of SS relative to the ACR effluent stream;
g.) discharging an aliquot portion of the ACR effluent stream in a manner that bypasses the membrane separation unit to provide an ACR discharge stream for disposal, recovery, and/or further utilization;
h.) passing at least a portion of the permeate stream to the ACR to provide additional liquid to in part maintain the desired upward fluid flow in the ACR such that the flocculant bed is maintained with an increased retention time of solids in the ACR; and,
i.) discharging at least a portion of permeate stream to provide a permeate discharge for disposal, recovery and/or further utilization.

21. The method of claim 20 wherein at least a portion of the concentrate stream passes to a solids management zone and treats the concentrate stream to produce a converted stream suitable for product production or energy recovery.

22. The method of claim 21 wherein the solids management zone screens and/or centrifuges the concentrate stream and then dries the resulting concentrated solids to produce nutrient rich solids suitable for fertilization.

23. The method of claim 20 wherein the animal husband operation maintains ruminant animals and the treating of step a.) is especially adapted for the removal of coarse fibrous solids.

24. The method of claim 20 wherein the pretreatment zone includes a biological treatment unit that provides hydrolysis and converts a portion of the pCOD to sCOD to reduce the TSS/VSS concentrations going the ACR.

25. The method of claim 20 wherein the AC coupled with the treatment of the concentrate from the membrane separation unit increases the solids retention time in the AC by a sufficient amount to reduce the required size of the membrane separation unit.
